(19) United States
(12) Patent Application Publication
(10) Pub. No.: US 2003/0192637 A1
(43) Pub. Date: Oct. 16, 2003

(54) Re-sawable repair of defective board of lumber

(76) Inventor: Thomas F. Cortese, Hayward, CA (US)

Correspondence Address: Harris Zimmerman, Suite 710, 1330 Broadway, Oakland, CA, 94612-2506, US

(21) Appl. No.: 10/121,162

(22) Filed: Apr. 11, 2002

(51) Int. Cl. B32B 31/00

(52) U.S. Cl. 156/98; 156/254; 428/63

(57) ABSTRACT

A board of lumber containing a defect, such as a knot, is repaired by cutting an opening between major surfaces of the board and filling the opening with a plug of adhesive filler material or a wood plug which is adhered to the wall of the opening. The opening and plug are formed to have a non-circular shape. This facilitates re-sawing of the board to form two thinner boards as the shape of the plug prevents it from being loosened by turning forces created by the saw blade which is used to effect the re-sawing operation. In some of the repair configurations, portions of the plug which remain in both of the thinner boards following re-sawing also cannot be dislodged by external forces exerted against the surfaces of the board.

### BACKGROUND OF THE INVENTION

This invention relates to the repair of defective boards of lumber or the like and more particularly to repair of boards in which knotholes or other defects are removed and replaced with filler material.

Wooden boards as first produced at a sawmill may contain defects which detract from the quality of the boards or make them useless for some purposes. Knots are a common problem of this kind. Other defects may be caused by impact damage, pitch pockets, decayed areas and openings excavated by birds or insects. Defects of these types can be repaired by cutting the defective region out of the board and filling the resulting opening with a hardenable plug of adhesive filler material or with a wood plug that is held in place with adhesive.

It is preferable that the opening which is cut into the board to receive the plug and the plug itself have shapes which mechanically interlock the plug into the board as plugs relying wholly on adhesion for the purpose can sometimes be dislodged by external forces which may be exerted against the board. My prior U.S. Pat. Nos. 4,894,971 and 5,440,859 disclose advantageous board repair configurations of this interlocked kind. My prior U.S. Pat. No. 4,941,305 discloses similar interlocking of plugs into openings that extend to an edge of a board.

Boards which have been initially sawed to have a particularly thickness may be re-sawed along a plane extending between the ends of the board to produce two boards of smaller thickness. This may be done, for example, in the manufacture of bevel siding which is used too form the outer wall of buildings or other structures. A bevel siding board has an upper edge that is narrower than the lower edge of the board and a slanted outer surface that extends between the two edge of differing thickness. The re-sawing process enables two of the bevel siding boards to be made from a single thicker rectangular board and thereby avoids wastage of lumber.

Problems can be encountered when prior forms of repaired board of the above described kind are re-sawed in the above described manner. The saw blade which is used to perform the re-sawing operation exerts a twisting or turning force on the repair plug. This turning force may be sufficient to break the adhesion of the plug to the wall of the opening in which it is seated and thereby loosen the plug in the board. Avoiding this problem by delaying the repair operation until after the re-sawing step complicates the repair process as two separate repairs must then be made.

Depending on the configuration of the particular plug, re-sawing of the above described kind may also disrupt the above, discussed interlocking which protects the plug against dislodgment by external forces exerted against the surfaces of the board. The portions of the plug which remain in one or both of the thinner boards that are produced by re-sawing are no longer interlocked and may be dislodged by external forces which are directed against the board.

The present invention is directed to overcoming one or more of the problems discussed above. BRIEF DESCRIPTION OF THE INVENTION

In, one aspect of the present invention, a method of repairing a defect in a board of lumber includes the step of cutting an opening through the board at the location of the defect to remove the defect which opening extends from a first major surface of the board to a second major surface of the board. The opening is formed to be of greater width in one direction than in another differing direction. Further step in the method include filling the opening with a conforming plug of material and forming two thinner repaired boards by re-sawing the board including the plug along a planar zone that extends between the ends of the board between the major surfaces.

In another aspect, the invention provides a method of repairing a defective board of lumber in which an opening is cut through the board to remove a defect which opening extends from one major surface of the board to the other major surface of the board. The opening is shaped to have a width which both increases and decreases within a first region of the board and also increases and decreases within a second region of the board, the first region of the board being between the one major surface of the board and a planar zone which extends along the board at a location which is between the major surfaces thereof, the second region of the board being between the other major surface of said board and the planar zone. The opening is also formed to be wider in a first direction that extends parallel to the major surfaces of the board than in a second differing direction which also extends parallel to the major surfaces. The opening is then filled with a conforming plug of material.

In still another aspect the invention provides a repaired board of lumber having an opening which extends between first and second major surfaces of the board, the opening being filled with a conforming plug of material. The opening has a width which both increases and decreases within a first region of the board and also increases and decreases within a second region of the board, the first region being between the first major surface of the board and a planar zone which extends along the board at a location which is between the major surfaces and the second region being between the second major surface of the board and the planar zone. The opening is wider in a first direction that extends parallel to the major surfaces than in a second differing direction which also extends parallel to the major surfaces.

Repair of a board of lumber in accordance with the invention provides an improved conforming plug in an opening which has been cut through the board to remove a knot or other defect. The board can be re-sawed along a planar zone which extends between the ends of the board to form two thinner boards without loosening of the plug by turning forces created by the saw blade which is used for the purpose. Portions of the plug which remain in both of the thinner boards are locked against rotation during the re-sawing operation by the non-circular shape of the plug and the repair remains locked against rotation if the repaired board is re-sawed along a plane within the board to form two boards of lesser thickness. In some forms of the invention, the portions of the repair which are in both thinner boards cannot be loosened by a turning force created by the saw or other tool that is used to effect the re-sawing operation and also cannot be dislodged by external forces directed towards the major surfaces of the board.

The invention, together with further objects and advantages thereof, may be further understood by reference to the following detailed description of the invention and by reference to the accompanying drawings.

### BRIEF DESCRIPTION OF THE DRAWINGS

FIG. 1 is a plan view of s board of lumber in which several defects have been repaired in accordance with the method of the present invention.

FIG. 2 is an elevation view of the board of lumber of FIG. 1, a portion of FIG. 2 being broken out to illustrate an initial step in the repair method.

FIG. 3 is an elevation view corresponding to the right hand portion of FIG. 2 and depicting a subsequent step in the repair method.

FIG. 4 is a perspective view illustrating still another step in the repair method of this embodiment wherein the repaired board is re-sawed to form two thinner boards.

FIG. 5 is an elevation view showing a typical usage of the thinner boards produced by the re-sawing step of FIG. 4.

FIG. 6 illustrates adaptation of the method to repair of a board having defective areas which inter-sect an edge of the board.

FIG. 7 is a view of a portion of a board of lumber in which a defect has been repaired by another embodiment of the method of the present invention.

FIG. 8 is a section view taken along line 8-8 of FIG. 7.

FIG. 9 is a view of a portion of a board of lumber in which a defect has been repaired by still another embodiment of the method of the present invention.

FIG. 10 is a section view taken along line 10-10 of FIG. 9.

FIG. 11 is a perspective view of a portion of a board of lumber as repaired in accordance with another embodiment of the invention.

FIG. 12 is a section view taken along line 12-12 of FIG. 11.

FIG. 13 is a section view corresponding to FIG. 12 and illustrating an intermediate step in the repair method of FIGS. 11 and 12.

### DETAILED DESCRIPTION OF THE INVENTION

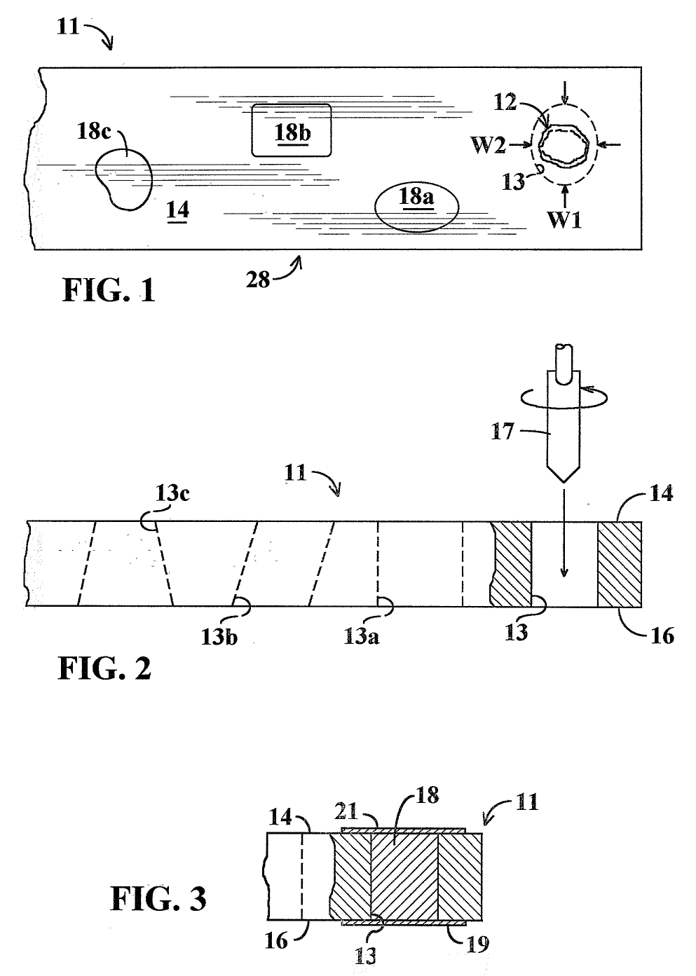

Referring initially to FIGS. 1 and 2 of the drawings, a board 11 of lumber as initially produced may have one or more defects 12 which may, among other examples, be knots, knotholes, pitch pockets, excavations made by birds or insects or impact damage. Defects of this kind can make the board 11 structurally and/or cosmetically unsuitable for many purposes. Wastage of wood can be avoided by repairing such defects.

Repair of a defective board 11 in accordance with this embodiment of the present invention includes the step of cutting an opening 13 through the board at the site of the defect 12 which defect is a knothole in this particular example. The opening 13 extends from a first major surface 14 of the board 11 to the opposite second major surface 16 of the board 11 and is of sufficient size to remove the defect 12. The opening 13 may be cut with a rotary tool 17 such as the cutting element of a router or with other tools known to those skilled in the woodworking art.

Referring to FIG. 3, opening 13 is then filled with material which forms a plug 18 having a shape which conforms with the shape of the opening. Plug 18 may be formed of a filler material which is initially semiliquid and which hardens and adhesively bonds to the wall of the opening 13, plastic wood or wood paste being suitable examples. A strip 19 of adhesive coated tape may be used to close the lower end of opening 13 during filling of the opening and another such strip 21 may cover the top of the filler material after it is emplaced to provide smooth end surfaces on plug 18 that are flush with the major surfaces 14 and 16 of board 11. Tapes 19 and 21 may be removed by sanding or other means after the filler material has hardened.

Instead of using filler material, plug 18 may be formed from solid wood or other solid material and be secured in the opening 13 with adhesive.

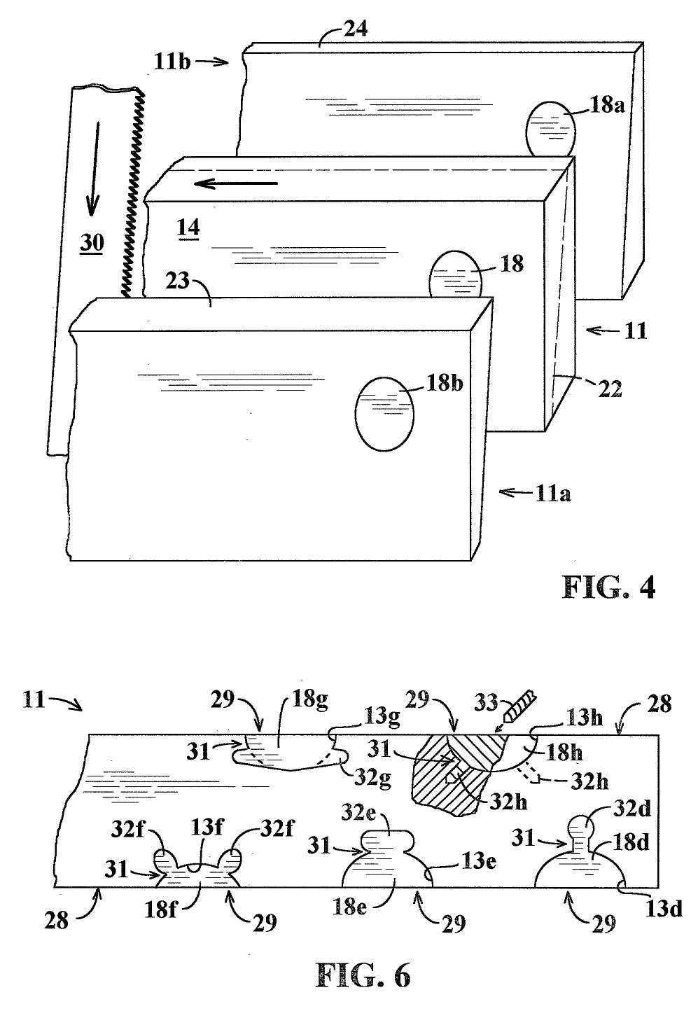

Referring now to FIG. 4, the repaired board 11 including plug 18 may be re-sawed along a planar zone 22 which extends between the major surfaces of the board and from one end of the board to the other end in order to form two thinner repaired boards 11a and 11b. Portions 18a and 18b of plug 18 remain present in each of the thinner boards 11a and 11b making separate repairing of the two thinner boards unnecessary.

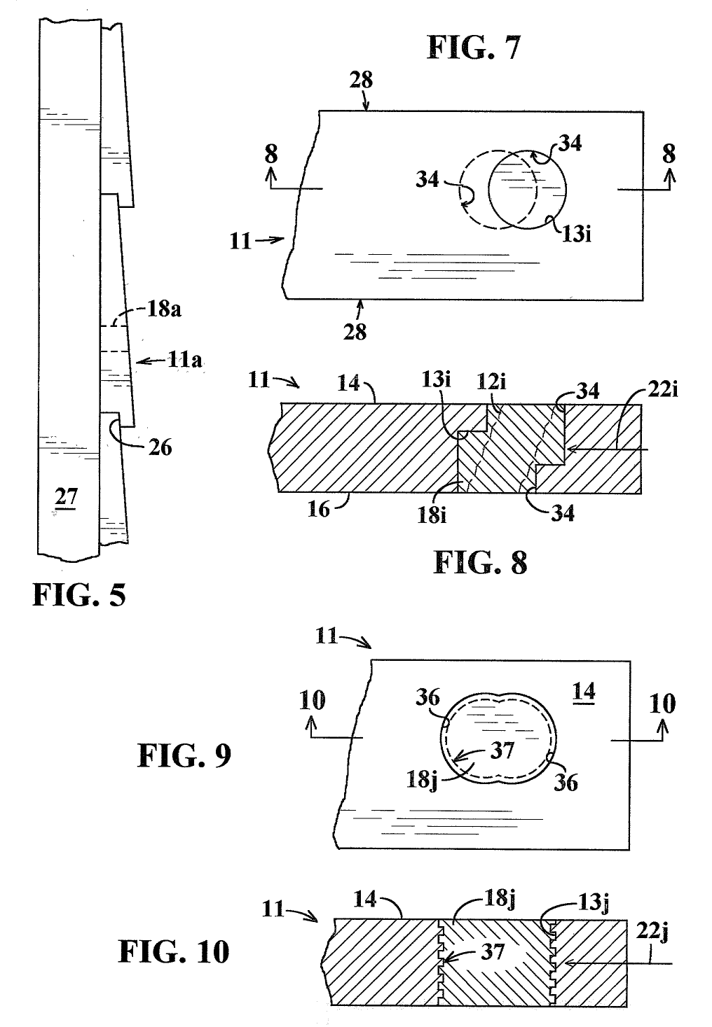

In this particular example of the invention, the planar zone 22 along which re-sawing takes place is slightly inclined relative to the major surfaces of the board 11 causing each of the two thinner boards 11a and 11b to have one edge 23 which is thicker than the opposite edge 24. Referring to FIG. 5, this makes the thinner boards 11a and 11b suitable for use as bevel siding boards of the type which are often used to form the outermost wall of buildings. Rabbet grooves 26 are cut into the thicker edges of such boards in order to enable the boards to overlap each other for a short distance and the boards are nailed to inner wall members of a building such as studs 27.

Referring again to FIG. 4, the planar zone 22 along which the repaired board 11 is re-sawed may be parallel to the major surfaces of the board in instances where the thinner boards 11a and 11b are to have a strictly rectangular shape.

Motion of the saw 30 which is used to perform the re-sawing step exerts a twisting or turning force on plug 18 which tends to rotate the plug within opening 13. The force can be of sufficient magnitude to break the adhesive bond of a circular plug to the wall of the opening thereby creating a loose plug. This does not occur in the practice of the present invention as opening 13 and thus plug 18 are shaped to prevent rotation of the plug. In particular, with reference again to FIGS. 1 and 2, opening 13 and the plug 18 are formed to be of greater width in one direction W1 than in another differing direction W2. The differing directions W1 and W2 are at right angles to each other in this particular embodiment although that is not essential.

Opening 13 and plug 18 have an oval shape in the above described example of the invention and are oriented at right angles to the major surfaces 14 and 16 of board 11 but this is also not essential. As illustrated by additional openings 13a, 13b and 13c and plugs 18a, 18b, 18c, the repair may have any of a variety of other non-circular shapes and may have other orientations. This can minimize the size of the repair while accommodating to defects of different shape. Opening 13b and plug 18b, for example, have an essentially rectangular shape and extend at an angle relative to surfaces 14 and 16 of the board. The angling minimizes the amount of wood which must be removed while accommodating to a knot or the like that extends through the board 11 at an angle. Opening 13c and plug 18c are of irregular outline and are of increasing size in the direction of board surface 16. This shape minimizes the size of the repair while accommodating to defects which are larger at one surface of the board than at the other.

Referring to FIG. 6, some defects, may intersect an edge 28 of the board 11. It is then necessary that the openings and conforming plugs, such as openings 13d, 13e, 13f, 13g and 13h and their plugs 18d, 18e, 18f, 18g and 18h respectively, be formed to have a linear boundary 29 which aligns with the adjacent edge 28 of the board 11. These truncated plugs 18d, 18e, 18f, 18g, and 18h continue to be locked against rotation during re-sawing if they are otherwise formed in the hereinbefore described manner. However the plugs may be subject to dislodgment in an outward direction from the adjacent edge 28 of the board. This can be prevented by forming the openings and their conforming plugs to have a constriction 31 between the adjacent edge 28 of the board and a region of the board which is located inward from the edge.

The constriction 31 is formed by causing one portion of the opening and plug to be of smaller extent in a direction parallel to the board edge 28 than at another portion of the opening that is further away from the board edge. For example, opening 13d and plug 18d are formed with an extension 32d which is narrower than the linear boundary 29 of the repair at one location and which expands to be circular and of greater extent at another location that is further from the linear boundary. Extensions of the opening and plug meeting this criteria can take various other forms such as is depicted at opening 13e and plug 18e. Opening 13f and the plug 18f have a pair of lobe extensions 32f which are angled away from each other. Functionally similar lobe extensions 32g at opening 13g and plug 18g extend directly away from each other. Extensions 32 for this purpose need not be visible at the surfaces of the board 11. For example, a pair of diverging lobe extensions 32h at opening 13h are formed by drilling bores within the interior of the board 11 with a drill bit 33 prior to emplacement of the filler material.

FIGS. 7 and 8 depict an embodiment of the invention in which the repair opening 13i is formed by drilling two circular bores 34 into the board 11 each of which extends only partly through the board. Inner end portions of the bores 34 overlap each other and thus the bores jointly form a continuous opening 13i which meets the hereinbefore described criteria for preventing rotational loosening of the plug 18i during the re-sawing operation. At the overlapping region of the bores 34, the width of the opening 13i is greater in a direction that extends along the board than it is in a direction that extends between the edges 28 of the board. This condition is still met even if the opening 13i is formed by two circular bores 34 which are simply drilled into the board 11.

The repair depicted in FIGS. 7 and 8 can reduce the amount of wood which must be removed from the board 11 in instances where the defect 12i which is removed extends through the board at an angle.

Following re-sawing along a planar zone 22i which extends along the interior of the board 11, the portions of plug 18i which remain in each of the resulting two thinner boards can not be dislodged by external forces directed against the surfaces of the thinner boards that where produced by the re-sawing operation.

Re-sawing of the repaired board of FIGS. 7 and 8 in the previously described manner is preferably done along a planar zone 22i which intersects the over-lapped regions of bores 34. The portions of plug 18i which remain in each of the two thinner boards that are produced in this manner cannot be dislodged by external forces which are directed against the new surfaces of the board that are produced by the re-sawing. In the case of bevel siding boards, as may be seen by referring again to FIG. 5, these are the outside facing surfaces of the bevel siding and thus are more likely to be impacted by external forces.

It can be advantageous in many usages of repaired boards if the portions of the plugs which remain in both of the two thinner boards that are produced by re-sawing are structurally locked in place and cannot be dislodged by external forces acting against either of the major surfaces of the thinner boards. This can be provided for by causing each such portion of the plug to have a width which changes at a first location within the thinner board and which has a reversed change at another location within the thinner board. FIGS. 9 and 10 jointly depict another embodiment of the invention which meets this criteria.

In the embodiment of FIGS. 9 and 10 the opening 13j which contains the conforming plug 18j is formed by two overlapping circular bores 36 each of which extends completely through the board 11. The non-circular shape of the opening 31j and plug 18j prevents rotation of the plug by saw forces during re-sawing of the board along an interior planar zone 22j. Bores 36 are formed to have internal threads 37 and thus the conforming plug 18j exhibits external threads which engage the internal threads. Saw forces cannot unscrew the plug 18j during the re-sawing operation as the plug cannot rotate. The increases and decreases in the width of the plug 18j created by threads 37 prevent later ejection of the plug 18j from the thinner boards by external forces which may be exerted against the boards.

Threads 37 can be replaced by a series of grooves in the wall of opening 13j which will also prevent ejection of the plug 18j by external forces.

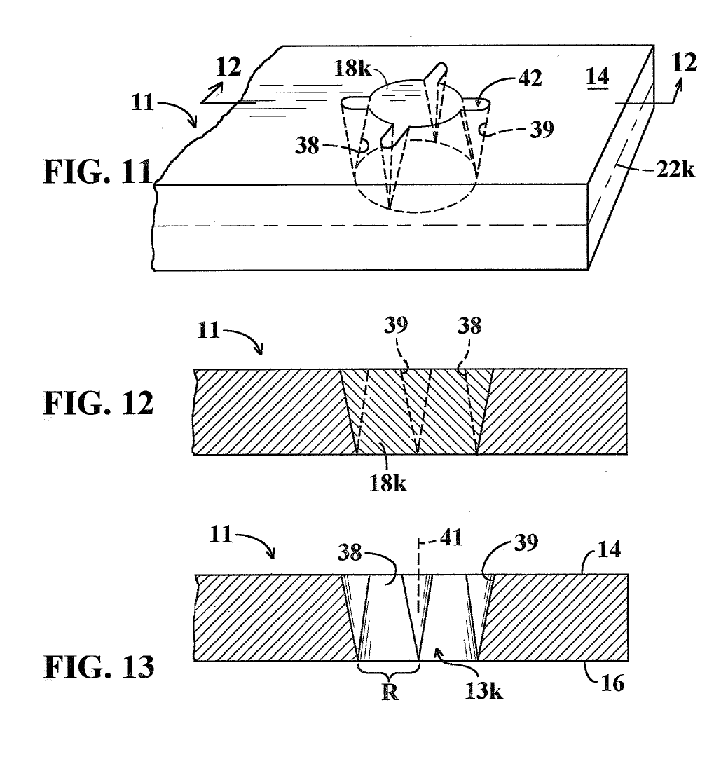

FIGS. 11, 12 and 13 depict another repair configuration in which a non-rotatable plug 18k cannot be ejected by external forces including after re-sawing of the board along an interior planar zone 22k. The opening 13k which contains the conforming plug 18k is formed by initially cutting a tapered circular passage 38 through the board 11. Grooves 39 are formed in the wall of passage 38 and extend between the major surfaces 14 and 16 of the board. Grooves 39 have a depth which progressively increases in the direction of the board surface 14 at which the smaller diameter end of passage 38 is located. The increase in depth is sufficient to cause the grooves 39 to extend outward from the axis 41 of tapered passage 38 at board surface 14 for a distance that exceeds the radius R of the larger end of the tapered passage.

The grooves 39 cause plug 18k to have lobes 42 which prevent rotation of the plug by saw forces during re-sawing. Following re-sawing to form two thinner boards, the diverging lobes 42 in conjunction with the converging wall of tapered passage 38 prevents ejection of the plug 18k by external forces acting against either surface of each of the thinner boards.

While the invention has been described with reference to certain specific embodiments for purposes of example, many modifications and variations are possible and it is not intended to limit the invention except as defined by the following claims.

What is claimed is:

1. In a method of repairing a defect in a board of lumber, the steps comprising cutting an opening through said board at the location of the defect to remove said defect which opening extends from a first major surface of the board to a second major surface of the board including forming said opening to be of greater width in a first direction than in a second differing direction, filling the opening with a conforming plug of material, and forming two thinner repaired boards by re-sawing said board including said plug along a planar zone that extends between ends of the board between said major surfaces.

2. The method of claim 1 wherein said opening is formed to have a width which both increases and decreases within a first region of said board and also increases and decreases within a second region of said board, said first region of said board being between said first major surface of said board and a planar zone which extends along the board at a location which is between said major surfaces thereof, said second region of said board being between said second major surface of said board and said planar zone.

3. The method of claim 2 wherein cutting of said opening includes forming two overlapping cylindrical bores in said board which bores extend through said board and by forming internal threads in said bores.

4. The method of claim 2 wherein cutting of said opening includes forming a tapered passage in said board which passage has a smaller end at one of said major surfaces and a larger end at the other of said major surface, and includes forming at least one groove which extends along said tapered passage in communication therewith, successive portions of said groove that are adjacent to successively narrower portions of said tapered passage being progressively deeper, the increasing depth of said groove being made sufficient to cause said groove to extend outward from the axis of said tapered passage at the smaller end thereof for a distance that exceeds the radius of said tapered passage at the larger end thereof.

5. The method of claim 1 wherein said opening intersects an edge of said board wherein cutting of said opening includes forming the opening to have a constriction between said edge 28 of the board and a regions of the board which is located inward from the edge.

6. The method of claim 1 wherein cutting of said opening includes forming two circular bores which extend between said major surfaces of said board and which overlap each other.

7. The method of claim 1 wherein said opening is formed by forming two bores in said board which bores extend inward from opposite ones of said major surfaces of said board and each of which extends only partially through said board and which overlap each other at the region of said planar zone.

8. The method of claim 1 wherein said opening is formed to extend through said board in an angled relationship to said major surfaces thereof.

9. The method of claim 1 including forming said opening to have a truncated conical shape.

10. In a method of repairing a defective board of lumber in which an opening is cut through the board to remove a defect therein which opening extends from one major surface of the board to the other major surface of the board and wherein the opening is filled with a conforming plug of material, the further steps comprising:
forming said opening to have a width which both increases and decreases within a first region of said board and also increases and decreases within a second region of said board, said first region of said board being between said one major surface of said board and a planar zone which extends along the board at a location which is between said major surfaces thereof, said second region of said board being between said other major surface of said board and said planar zone, and wherein said opening is also formed to be wider in a first direction that extends parallel to said major surfaces than in a second differing direction which also extends parallel to said major surfaces.

11. A repaired board of lumber wherein an opening which extends between one major surface and an opposite major surface of the board is filled with a conforming plug of material, said opening having a width which both increases and decreases within a first region of said board and also increases and decreases within a second region of said board, said first region of said board being between said one major surface of said board and a planar zone which extends along the board at a location which is between said major surfaces thereof, said second region of said board being between said opposite major surface of said board and said planar zone, said opening being wider in a first direction that extends parallel to said major surfaces than in a second differing direction which also extends parallel to said major surfaces.
